(19) United States
(12) Patent Application Publication
(10) Pub. No.: US 2026/0335160 A1
(43) Pub. Date: Oct. 29, 2026

(54) SURGICAL TRAY

(71) Applicant: Saif Zaman, Snellville, GA (US)

(72) Inventor: Saif Zaman, Snellville, GA (US)

(21) Appl. No.: 19/653,215

(22) Filed: Apr. 21, 2026

Related U.S. Application Data
(60) Provisional application No. 63/795,778, filed on Apr. 28, 2025.

(51) Int. Cl. A61G 13/12; A61G 13/10

(52) U.S. Cl. CPC A61G 13/125; A61G 13/102

(57) ABSTRACT

A surgical tray includes a support portion having a ramp and a collection basin adjacent the ramp. The ramp has a ramp floor, and the collection basin has a basin floor disposed below the ramp floor such that fluid received on the ramp floor flows into the collection basin. The surgical tray may support a patient extremity during a surgical procedure and may collect fluids generated during the surgical procedure. In some implementations, the ramp supports a first portion of the patient extremity and the collection basin supports a second portion of the patient extremity. The surgical tray may include a drain tube in fluid communication with the collection basin. In some implementations, the surgical tray is formed as a single piece and formed from a radiolucent or substantially radiolucent material.

### CROSS-REFERENCE TO RELATED APPLICATION

This application claims the benefit of U.S. Provisional Application Ser. No. 63/795,778, filed on Apr. 28, 2025, the entirety of which is incorporated herein by reference.

### TECHNICAL FIELD

This disclosure relates to surgical trays, and more specifically to surgical trays configured to support a patient extremity and manage fluids during surgical procedures.

### BACKGROUND

Minimally invasive surgical procedures involving a patient extremity, such as a foot or hand, often involve the use of a surgical burr, such as a Shannon burr. Saline irrigation may be used to cool and/or lubricate the surgical burr, which may result in excess fluid pooling in and around the operative area. In some instances, existing fluid-management techniques may be ineffective, thereby creating challenges in maintaining a clean surgical field, increasing cleanup time, and delaying operating room turnover. Such techniques may also contribute to splatter and biohazardous contamination within the operating room suite.

### SUMMARY

It is to be understood that this summary is not an extensive overview of the disclosure. This summary is exemplary and not restrictive, and it is intended neither to identify key or critical elements of the disclosure nor to delineate the scope thereof. The sole purpose of this summary is to explain and exemplify certain concepts of the disclosure as an introduction to the following complete and detailed description.

Implementations of a surgical tray are disclosed. The surgical tray is configured to support a patient extremity during a surgical procedure and to capture fluids generated during the surgical procedure.

In one example implementation, a surgical tray comprises a support portion including a ramp and a collection basin. The ramp includes a ramp floor, and the collection basin is positioned adjacent the ramp and has a basin floor disposed below the ramp floor. The ramp floor is inclined such that fluid received on the ramp floor flows into the collection basin.

In another example implementation, a surgical tray comprises a support portion including a ramp and a collection basin. The ramp is configured to support a first portion of a patient extremity, and the collection basin is positioned adjacent the ramp and configured to collect fluid and support a second portion of the patient extremity. The ramp is elevated relative to a basin floor of the collection basin and configured so that fluid on the ramp drains into the collection basin.

Also disclosed are implementations of a method of managing fluid during a surgical procedure.

In one example implementation, a method of managing fluid during a surgical procedure comprises positioning a surgical tray on a surgical table, the surgical tray including a support portion having a ramp and a collection basin adjacent the ramp; supporting a patient extremity on the support portion such that a portion of the patient extremity rests on the ramp; and performing the surgical procedure while fluid flows from the ramp and is collected in the collection basin.

Any of the implementations herein, wherein the ramp includes a lower end positioned adjacent the collection basin.

Any of the implementations herein, wherein the ramp includes one or more sidewalls extending upwardly from the ramp floor along three sides of the ramp floor.

Any of the implementations herein, wherein the one or more sidewalls include one or more cutouts.

Any of the implementations herein, wherein the collection basin includes one or more basin sidewalls extending upwardly from the basin floor.

Any of the implementations herein, wherein the one or more basin sidewalls include one or more cutouts.

Any of the implementations herein, further comprising a drain tube in fluid communication with the collection basin.

Any of the implementations herein, wherein the drain tube extends through a basin sidewall of the collection basin.

Any of the implementations herein, wherein the drain tube includes a first end positioned within the collection basin and a second end positioned outside the collection basin.

Any of the implementations herein, wherein a basin sidewall of the collection basin is positioned adjacent a lower end of the ramp, and an upper edge of the basin sidewall is joined to the lower end of the ramp to define a transition region between the ramp floor and the collection basin that permits fluid to flow from the ramp floor into the collection basin.

Any of the implementations herein, wherein the surgical tray comprises a radiolucent or substantially radiolucent material.

Any of the implementations herein, wherein the surgical tray is formed as a single piece.

Any of the implementations herein, wherein the patient extremity comprises a foot, an ankle, or both.

Any aspect of any implementation may be combined with any one or more aspects of any other implementation(s).

Any one or more of the features disclosed herein may be used alone or in combination.

Any one or more of the features as substantially disclosed herein.

Any one or more of the features as substantially disclosed herein, in combination with any one or more other features as substantially disclosed herein.

Any one of the aspects, features, or implementations, in combination with any one or more other aspects, features, or implementations.

Use of any one or more of the aspects or features disclosed herein.

It should be appreciated that any feature described herein can be claimed in combination with any one or more other features described herein, regardless of whether the features originate from the same described implementation.

The details of one or more aspects of the disclosure are set forth in the accompanying drawings and the description below. Other features, objects, and advantages of the techniques described in this disclosure will be apparent from the description and drawings, and from the claims.

Numerous additional features and advantages of the present disclosure will become apparent to those skilled in the art upon consideration of the implementation descriptions provided below.

Additional features and advantages are described herein and will be apparent from the following description and figures.

### BRIEF DESCRIPTION OF THE DRAWINGS

FIG. 1 is a perspective view of a surgical tray according to the principles of the present disclosure.

FIG. 2 is another perspective view of the surgical tray shown in FIG. 1.

FIG. 3 is a side elevation view of the surgical tray shown in FIG. 1.

FIG. 4 is a front elevation view of the surgical tray shown in FIG. 1.

FIG. 5 is a perspective view showing a foot and ankle resting in a first orientation on the surgical tray shown in FIG. 1.

FIG. 6 is a perspective view showing a foot and ankle resting in a second orientation on the surgical tray shown in FIG. 1.

Like reference numerals refer to corresponding parts throughout the several views of the drawings.

### DETAILED DESCRIPTION

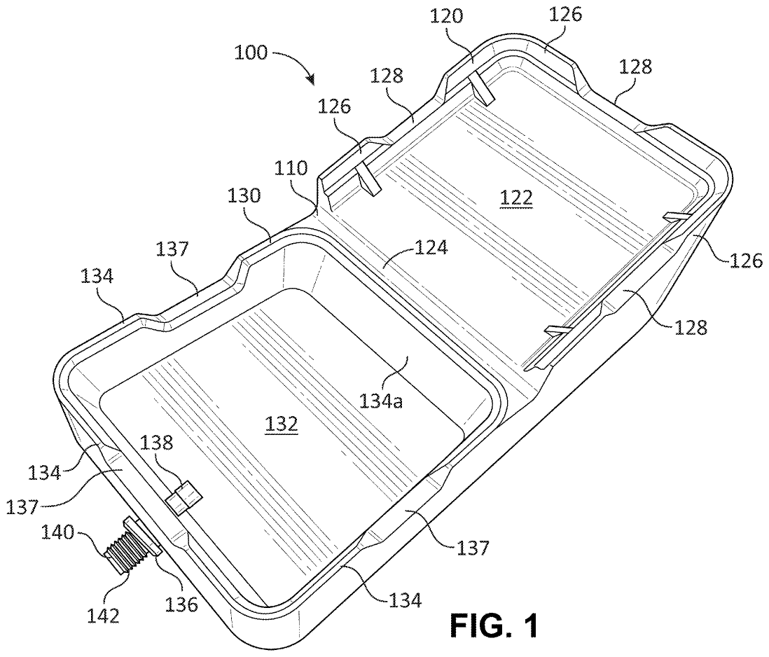

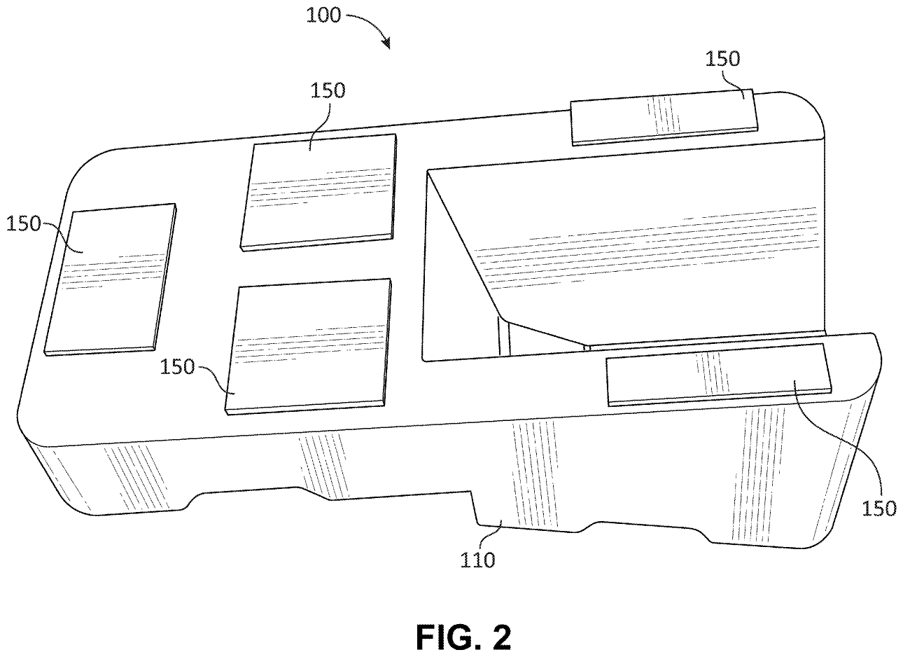

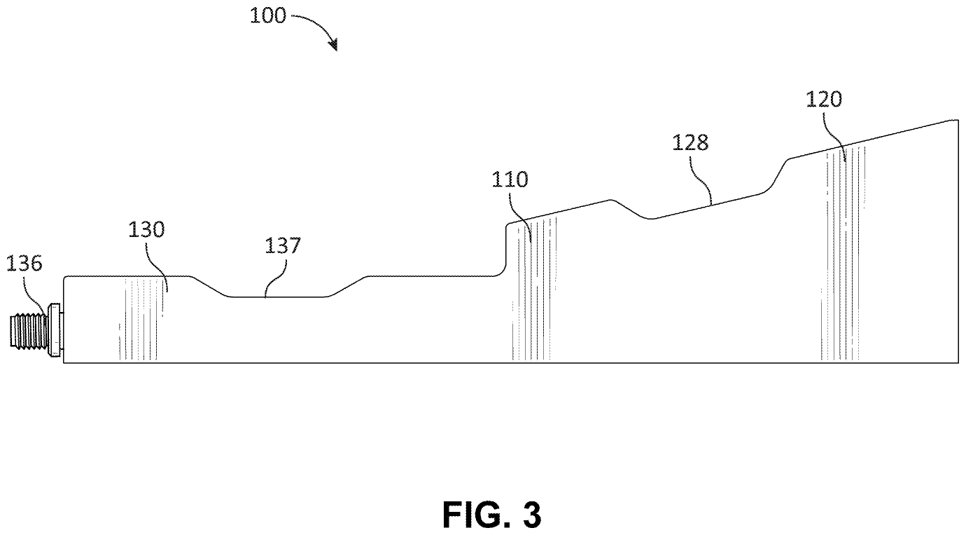

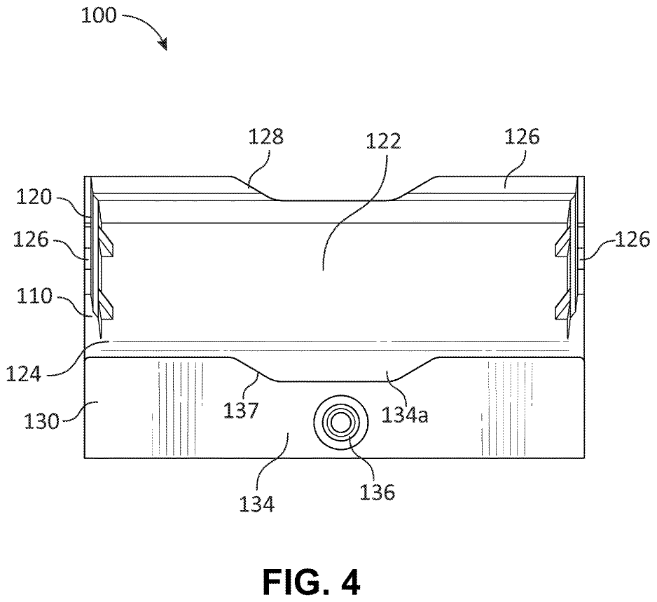

FIGS. 1-6 illustrate a surgical tray 100 according to the principles of the present disclosure. The surgical tray 100 is configured for use during surgical procedures involving a patient extremity, such as the foot and ankle or the hand and wrist, and functions as a patient-extremity support and fluid-management device. The surgical tray 100 is configured to capture fluids generated during a surgical procedure, such as saline, irrigation fluid, and blood. For example, saline may be introduced during a surgical procedure to cool and/or lubricate a surgical burr, such as a Shannon burr, or another surgical instrument.

The surgical tray 100 is configured to support a patient extremity and comprises a support portion 110 including a ramp 120 and a collection basin 130. The collection basin 130 is configured to collect fluids, such as saline, irrigation fluid, and blood. The surgical tray 100 is configured to rest on a surgical table.

The ramp 120 includes a ramp floor 122 positioned above a floor 132 of the collection basin 130, the ramp floor 122 being inclined so that fluid received on the ramp floor 122 flows toward the collection basin 130. In some implementations, a lower end 124 of the ramp 120 is positioned adjacent an edge of the collection basin 130. In some implementations, the ramp 120 may also include one or more sidewalls 126 extending upwardly from the ramp floor 122 and along three sides of the ramp floor 122, such that the end of the ramp floor 122 adjacent to the collection basin 130 is free of sidewalls 126 to permit fluid flow into the collection basin 130. In some implementations, each of the sidewalls 126 may include one or more cutouts 128 configured to allow access to a portion of the patient extremity resting on the ramp 120.

The collection basin 130 includes basin sidewalls 134 extending upwardly from the floor 132 and disposed along four sides of the floor 132. In some implementations, a basin sidewall 134a is positioned adjacent the lower end 124 of the ramp 120, and an upper edge of the basin sidewall 134a is joined to the lower end 124 of the ramp 120 to define a transition region between the ramp floor 122 and the collection basin 130 that permits fluid flow from the ramp floor 122 into the collection basin 130. In some implementations, the basin sidewall 134a has substantially the same width as the ramp floor 122. In some implementations, each of the basin sidewalls 134 may include one or more cutouts 137 configured to allow access to a portion of the patient extremity resting in the collection basin 130.

The collection basin 130 may also include a drain tube 136 extending through one of the basin sidewalls 134. A first end 138 of the drain tube 136 is positioned within the collection basin 130, and a second end 140 of the drain tube 136 is positioned on an opposite side of the basin sidewall through which the drain tube 136 extends. In some implementations, the drain tube 136 is configured to be coupled to a suction device to remove fluid collected in the collection basin 130. In some implementations, the second end 140 of the drain tube 136 may include a threaded portion 142 configured to be coupled to a suction device. In some implementations, the second end 140 of the drain tube 136 is configured to be coupled to a suction tube 144.

In some implementations, the surgical tray 100 may be secured to the surgical table. For example, an adhesive member, such as adhesive tape 150, may be positioned on the underside of the surgical tray 100 and configured to secure the surgical tray 100 to the surgical table. In some implementations, the adhesive tape 150 may inhibit movement of the surgical tray 100 relative to the surgical table during a surgical procedure. In some implementations, the surgical tray 100 may be secured using another suitable fastener, a combination of fasteners, or another suitable fastening structure.

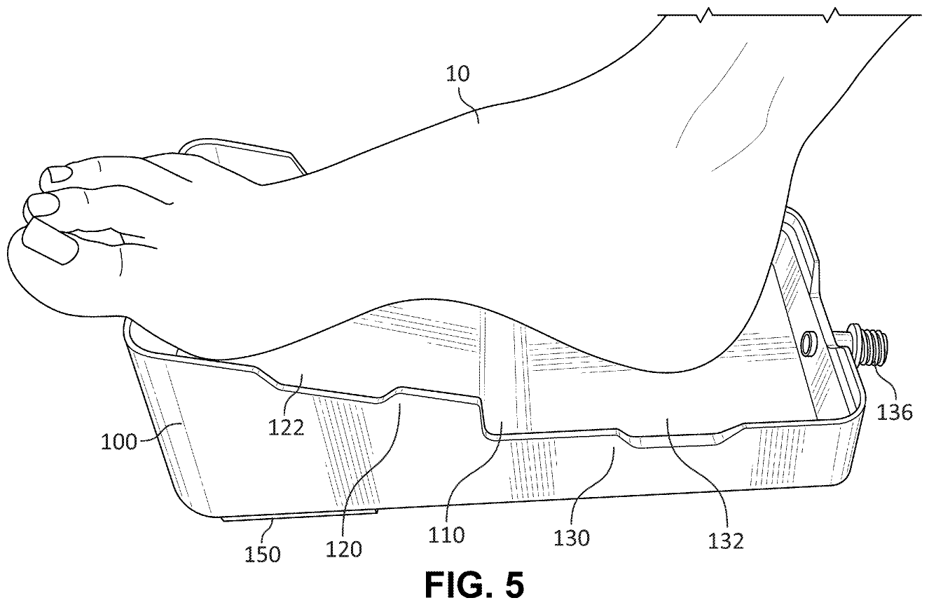

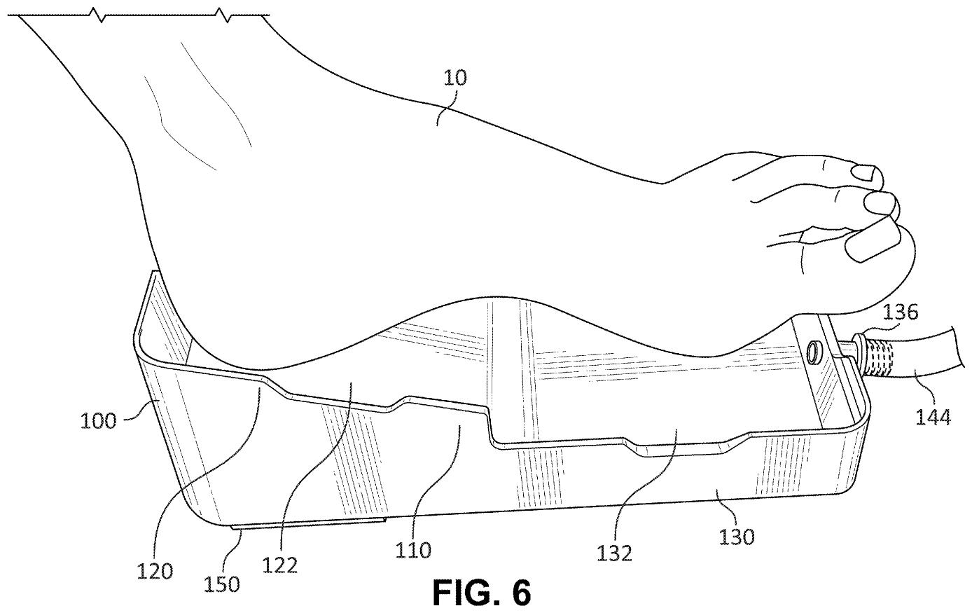

As shown in FIGS. 5 and 6, the support portion 110 of the surgical tray 100 is configured to support a patient extremity 10. While the illustrated patient extremity 10 is a foot and ankle, it should be understood that a hand and wrist may also be supported by the support portion 110 of the surgical tray 100.

As shown in FIG. 5, the patient extremity 10 may be positioned so that the heel portion of the foot is resting in the collection basin 130 and the forefoot portion of the foot is resting on the ramp 120.

As shown in FIG. 6, the patient extremity 10 may be positioned so that the heel portion of the foot is resting on the ramp 120 and the forefoot portion of the foot is resting in the collection basin 130.

The surgical tray 100 may be formed as a single piece from a radiolucent or substantially radiolucent material. In some implementations, one or more portions of the surgical tray 100 may be formed from a radiolucent or substantially radiolucent material. In some implementations, the surgical tray 100, or one or more portions thereof, may be formed from a polymeric material, including polycarbonate, polypropylene, or other suitable materials or combinations of materials. Use of a radiolucent or substantially radiolucent material may reduce imaging interference caused by the surgical tray 100, thereby facilitating fluoroscopic imaging during a surgical procedure.

The surgical tray 100 may be formed by additive manufacturing, injection molding, machining, or other suitable manufacturing techniques. In some implementations, the surgical tray 100 may be configured as a disposable, single-use device. In other implementations, the surgical tray 100 may be configured for reuse. In some implementations, the surgical tray 100 may be sterilized and packaged to maintain sterility prior to use.

The foregoing description of the present disclosure is intended to be illustrative; it is not intended to be exhaustive or to limit the claims to the precise forms disclosed. Those skilled in the relevant art will appreciate that many modifications and variations are possible in light of the foregoing description and associated drawings.

Reference throughout this specification to an “embodiment,” “implementation,” or words of similar import indicates that a particular described feature, structure, or characteristic is included in at least one embodiment of the present disclosure. Thus, the phrase “in some implementations,” or a phrase of similar import, as used throughout this specification, does not necessarily refer to the same embodiment.

The described features, structures, or characteristics may be combined in any suitable manner in one or more embodiments. In the above description, numerous specific details are provided for a thorough understanding of embodiments of the present disclosure. One skilled in the relevant art will recognize, however, that embodiments of the present disclosure can be practiced without one or more of the specific details, or with other methods, components, materials, etc. In other instances, well-known structures, materials, or operations may not be shown or described in detail.

1. A surgical tray comprising:
a support portion including:
a ramp having a ramp floor; and
a collection basin positioned adjacent the ramp and having a basin floor disposed below the ramp floor;
wherein the ramp floor is inclined such that fluid received on the ramp floor flows into the collection basin.

2. The surgical tray of claim 1, wherein the ramp includes a lower end positioned adjacent the collection basin.

3. The surgical tray of claim 1, wherein the ramp includes one or more sidewalls extending upwardly from the ramp floor along three sides of the ramp floor.

4. The surgical tray of claim 3, wherein the one or more sidewalls include one or more cutouts.

5. The surgical tray of claim 1, wherein the collection basin includes one or more basin sidewalls extending upwardly from the basin floor.

6. The surgical tray of claim 5, wherein the one or more basin sidewalls include one or more cutouts.

7. The surgical tray of claim 1, further comprising a drain tube in fluid communication with the collection basin.

8. The surgical tray of claim 7, wherein the drain tube includes a first end positioned within the collection basin and a second end positioned outside the collection basin.

9. The surgical tray of claim 1, wherein a basin sidewall of the collection basin is positioned adjacent a lower end of the ramp, and an upper edge of the basin sidewall is joined to the lower end of the ramp to define a transition region between the ramp floor and the collection basin that permits fluid to flow from the ramp floor into the collection basin.

10. The surgical tray of claim 1, wherein the surgical tray is formed from a radiolucent or substantially radiolucent material.

11. The surgical tray of claim 1, wherein the surgical tray is formed as a single piece.

12. A surgical tray comprising:
a support portion including:
a ramp configured to support a first portion of a patient extremity; and
a collection basin positioned adjacent the ramp and configured to collect fluid and support a second portion of the patient extremity;
wherein the ramp is elevated relative to a basin floor of the collection basin and configured so that fluid on the ramp drains into the collection basin.

13. The surgical tray of claim 12, further comprising a drain tube in fluid communication with the collection basin.

14. The surgical tray of claim 12, wherein the ramp includes a lower end positioned adjacent the collection basin.

15. The surgical tray of claim 12, wherein the surgical tray is formed from a radiolucent or substantially radiolucent material.

16. The surgical tray of claim 12, wherein the surgical tray is formed as a single piece.

17. The surgical tray of claim 12, wherein the patient extremity comprises a foot, an ankle, or both.

18. A method of managing fluid during a surgical procedure, the method comprising:
positioning a surgical tray on a surgical table, the surgical tray including a support portion having a ramp and a collection basin adjacent the ramp;
supporting a patient extremity on the support portion such that a portion of the patient extremity rests on the ramp; and
performing the surgical procedure while fluid flows from the ramp and is collected in the collection basin.

19. The method of claim 18, further comprising removing fluid from the collection basin.

20. The method of claim 18, wherein the patient extremity comprises a foot, an ankle, or both.
